(19) United States
(12) Patent Application Publication
(10) Pub. No.: US 2019/0351637 A1
(43) Pub. Date: Nov. 21, 2019

(54) ALUMINUM HONEYCOMB CORE PRODUCTION METHOD AND DEVICE

(71) Applicant: Honicel Honeycomb Material Holdings Ltd., Guangzhou (CN)

(72) Inventors: Wenming Wang, Guangzhou (CN); Shuai Huang, Guangzhou (CN); Ke Cheng, Guangzhou (CN); Junwei Duan, Guangzhou (CN); Zhihui Liao, Guangzhou (CN)

(21) Appl. No.: 16/529,837

(22) Filed: Aug. 2, 2019

Related U.S. Application Data
(63) Continuation of application No. PCT/CN2018/072965, filed on Jan. 17, 2018.

(30) Foreign Application Priority Data
Oct. 18, 2017 (CN) 201710971358.2

(51) Int. Cl. B31D 3/02

(52) U.S. Cl. CPC B31D 3/0292; B31D 3/023

(57) ABSTRACT

The present application relates to the producing field of honeycomb cores, and provides an aluminum honeycomb core production method and device, the method comprises: a gumming step: gumming adhesive to aluminum foil layers and then bond the aluminum foil layers to form a double/multi-layer aluminum foil; a pre-gumming step: gumming adhesive to the surface of the double/multi-layer aluminum foil; a cutting step: cutting the double/multi-layer aluminum foil; and a bonding step: bonding a plurality of the aluminum foil strips; and the apparatus is used to produce the aluminum honeycomb core according to the above method; the method can improve the structural strength and of the honeycomb core by applying aluminum foil to the honeycomb, and the apparatus can increase the production efficiency and the product quality of the aluminum honeycomb core.

### CROSS-REFERENCE TO RELATED APPLICATIONS

This application is a continuation of International Application No. PCT/CN2018/072965, filed on Jan. 17, 2018, which is hereby incorporated by reference in its entirety.

### TECHNICAL FIELD

The application relates to the field of honeycomb core manufacturing, and in particular to an aluminum honeycomb core, production method and device.

### BACKGROUND

At present, in the fields of building materials, movable board houses, decorative materials, automotive materials, air purification, etc., the structural requirements for the boards are getting higher and higher, and it is necessary to reduce the weight and the production cost while maintaining the structural strength, and the honeycomb structural board meets the requirement, the honeycomb board is generally made of a honeycomb-shaped paper core layer (hereinafter referred to as a paper honeycomb core) and two pressure plates bonded to the upper and lower surfaces of the paper honeycomb core. The paper honeycomb core is a kind of biomimetic structure product, which is made according to the structural characteristics of the honeycomb nest, each honeycomb cell inside is tightly connected, and each honeycomb cell is an equilateral hexagonal structure, the honeycomb board has excellent performances such as wind pressure resistance, shock absorption, sound insulation, heat preservation, flame retardancy and high specific strength, the performance is more superior than polygonal structures such as trilateral and quadrilateral. At present, the producing method of the paper honeycomb core is generally applied with glue (such as paste) on one side of each of the liner papers, and then stack and bond each of the liner papers, and the bonding method is to stagger the glue positions of adjacent liner papers from each other, and then bond the adjacent liner papers together. The glued positions are offset from each other for bonding.

However, regarding the existing paper honeycomb core, the applicant realized that:

(1) The paper honeycomb core adopts the liner paper as the production material, and the flame retardancy of the paper honeycomb board completely depends on the pressure plate which is on the surface of the paper honeycomb core, if the paper honeycomb core in the paper honeycomb board is fired, the fire will burn along the paper honeycomb core until the paper honeycomb core is completely burned, which has serious fire safety hazards.

(2) The traditional method for producing paper honeycomb core is applying ordinary glue to the liner paper by hand or equipment, and bonding the paper in sequence, and then cutting the paper honeycomb core according to the thickness requirement of the paper honeycomb core, and the thickness thereof is difficult to be unified, the cumbersome process also reduces the production efficiency of the paper honeycomb core.

(3) Since the paper honeycomb core is made of liner papers which has strong elastic strength, even if the paper honeycomb core is stretched and shaped, the paper honeycomb core will gradually shrink between the two pressure plate even the paper honeycomb core has been stretched and shaped, as the time goes by, the outer edge of the paper honeycomb board is inlaid with the edge strip of the board, therefore, if the paper honeycomb core shrinks after the paper honeycomb core is bonded in the pressure plates, the inner paper honeycomb core can no longer be stretched for the second time, and the paper honeycomb board, there is no guarantee that the paper honeycomb core will fill the inner space of the paper honeycomb board, resulting in a decrease in the quality and performance of the paper honeycomb core.

(4) The traditional producing method for paper honeycomb core is difficult to ensure the consistency of the offset width between the glue lines of the paper layers, and it is difficult to ensure the positioning accuracy of the bonding between paper layers in the stacking and bonding process, moreover, since a plurality of the paper cores need to be stacked and bonded and then consistently cut during manufacturing, the thickness of the stacked paper layer is easily cause the paper honeycomb core pressed to deformation by the cutting blade during the cutting process, to affect the quality of the paper honeycomb core.

### SUMMARY

In order to overcome the deficiencies of the conventional technology, one of the objects of the present application is to provide an aluminum honeycomb core production method, which applying aluminum foil to a honeycomb core structure, and the honeycomb core using aluminum foil not only does not shrink, but also improves the honeycomb core structural strength and safety performance thereof.

The second object of the present application is to provide an aluminum honeycomb core production device, which applying uniform height cutting before stacking and bonding aluminum foil layers, so that to improves the production efficiency of the aluminum honeycomb core, and also ensures the quality of the finished product of the aluminum honeycomb core.

The first object of the present application is achieved by the following technical solutions:

An aluminum honeycomb core production method, comprising the following steps:

a gumming step: gumming adhesive to aluminum foil layers and then bond the aluminum foil layers to form a double/multi-layer aluminum foil;

and gumming parallel glue lines on the surface of the aluminum foil layer at equal intervals along the length direction thereof, stacking the gummed aluminum foil layer with another aluminum foil layer, and then forming a double-layer aluminum foil by thermocompression bonding; and forming a first glue line layer between the two aluminum foil layers;

the double-layer aluminum foil can directly enter a subsequent pre-gumming step, or can further enter the subsequent pre-gumming step after the plurality of the double-layer aluminum foils are stacked and bonded to form a multi-layer aluminum foil, and forming a second glue line layer between any two adjacent two-layer aluminum foils;

a pre-gumming step: gumming adhesive to the surface of the double/multi-layer aluminum foil;

and gumming parallel glue lines on the surface of the double/multi-layer aluminum foil at equal intervals along the length direction thereof, and forming the second glue line layer on the gummed side surface of the double/multi-layer aluminum foil: the glue line of the first glue line layer and the second glue line layer is parallel and staggered;

a cutting step: cutting the double/multi-layer aluminum foil;

according to the thickness requirement of the aluminum honeycomb core, cutting the double/multi-layer aluminum foil along the width direction of the double/multi-layer aluminum foil, and cutting the double/multi-layer aluminum foil into a plurality of aluminum foil strips of the same size;

a bonding step: bonding a plurality of the aluminum foil strips;

according to the area requirement of the aluminum honeycomb core, setting the orientations of the second glue line layer of the aluminum foil strips to a consistent orientation, and stacking and bonding a plurality of the aluminum foil strips in sequence, and the plurality of the aluminum foil strips are parallel; so that a plurality of the first glue line layers and a plurality of the second glue line layers are alternately bonded to form an aluminum honeycomb core.

Preferably, the interval between any two adjacent glue lines of the first glue line layer is the same as the interval between any two adjacent glue lines of the second glue line layer.

Preferably, doing ultrasonic cleaning of the aluminum foil layer before the gumming step.

Preferably, the gumming step and the pre-gumming step both apply hot melt adhesive to gum the aluminum foil layer and the double/multi-layer aluminum foil.

Preferably, the method further comprises a stretching step after the bonding step; after the glue line in the aluminum honeycomb core is air-dried and solidified, applying a relatively outward pulling force to both ends of the aluminum honeycomb core in a direction perpendicular to the aluminum foil layer, to cause tensile deformation of the aluminum honeycomb core to form a unfolded honeycomb core.

Preferably, the thickness of the aluminum foil layer is 0.02 to 0.08 mm.

The second object of the present application is achieved by the following technical solutions:

An aluminum honeycomb core production device, comprising:

a cutting mechanism and a driving mechanism, and the driving mechanism is used for driving the cutting mechanism to shear the aluminum foil layer; the cutting mechanism comprises a working table, a limiting board, a moving knife and a fixed knife; the limiting board is located above the working table and forms a discharging passage with the working table, the discharging passage is for exporting the aluminum honeycomb core; the discharging passage is horizontally disposed, one end forms a discharging outlet, the other end forms a shearing part; the moving knife is drivingly connected to the driving mechanism located at one side of the shearing part, the fixed knife is fixed on the limiting board and disposed opposite to the moving knife; the driving mechanism is configured to drive the moving knife to reciprocate along the direction of the discharging passage, to make moving knife tangent to the fixed knife; the discharging passage is parallel to the horizontal plane; the moving knife and the fixed knife are arranged up and down, the cutting edge of the fixed knife is horizontally tangent to the cutting edge of the moving knife.

Preferably, the aluminum honeycomb core production device further comprises a guiding mechanism; the guiding mechanism is disposed above the cutting mechanism for guiding the glued double/multi-layer aluminum foil to the cutting mechanism for cutting the glued double/multi-layer aluminum foil by the cutting mechanism; the guiding mechanism comprises a guiding board and a stopping assembly; a guiding passage for the double/multi-layer aluminum foil to pass through is formed between the guiding board and the stopping assembly, the guiding passage is in communication with the discharging passage;

the guiding passage has is curved; one end of the guiding passage forms a feeding end, and the other end of the guiding passage forms a discharging end, the extension line of the feeding end intersects with the extension line of the discharging end at 90 degrees; the line formed between the discharging end and the shearing part is perpendicular to the discharging passage.

Preferably, the aluminum honeycomb core production device further comprises a first gumming mechanism and a second gumming mechanism; the first gumming mechanism and the second gumming mechanism are both connected to an external hot melt adhesive machine; the first gumming mechanism and the second gumming mechanism are disposed on the frame and are arranged stagger from each other, a plurality of guide rollers and a pressure roller for bonding the aluminum foil layer are disposed between the first gumming mechanism and the second gumming mechanism; the second gumming mechanism is at the same level as and the feeding end.

Preferably, the first gumming mechanism and the second gumming mechanism each comprise a glue-storing cavity and a glue-scraping blade; the glue-storing cavity is in communication with the external hot melt adhesive machine, the glue-storing cavity is configured to storage the hot melt adhesive exported and supplied by the external hot melt adhesive machine and to pre-heat the hot melt adhesive; the glue-scraping blade is installed below the glue-storing cavity, a plurality of glue outlets are equidistantly disposed at the glue-scraping blade along the length direction of the glue-storing cavity, and the glue outlets are communicate with the interior of the glue-storing cavity; the orthographic projections of the glue outlets of the first gumming mechanism and the glue outlets of the second gumming mechanism in the direction of the first gumming mechanism and the second gumming mechanism are staggered.

Compared with the conventional technology, the present application has the following beneficial effects:

(1) The application adopts aluminum foil to be applied in the honeycomb core structure, therefore the production process is also different from the conventional paper honeycomb core, and the method for producing the aluminum honeycomb core can not only successfully apply the aluminum foil to the honeycomb core structure, but also ensures the consistent structure of each honeycomb cell in the aluminum honeycomb core, and the strength of the aluminum honeycomb core is higher than that of the conventional paper honeycomb core, and the elastic strength of the aluminum is lower than that of the liner paper, after the aluminum honeycomb core is made into a aluminum honeycomb core board, the aluminum honeycomb core layer locating between the pressure plates can maintain a permanent non-shrinking state, to ensure the strength of the aluminum honeycomb core board; in addition, the flame retardancy of the aluminum foil is better than that of the liner paper, even if the fire enters the aluminum honeycomb core layer through the pressure plate, the aluminum honeycomb core will not be lit, so that it has better security performance. Moreover, the producing method adopts a cutting step for cutting the aluminum foil layer before the aluminum foil layer is stacked and pressed, thereby avoiding the condition that the aluminum foil layers are pressure-bonded during the cutting after the aluminum foil layers are stacked to form a multi-layer aluminum, thereby improving the production quality of the aluminum honeycomb core.

(2) Applying a aluminum foil to the honeycomb core structure by redesign of the mechanical structure, and after the gummed aluminum foil is continuously conveyed into the cutting mechanism, the aluminum foil contacts the working table, and the working table limits the aluminum foil and then the driving mechanism drives the moving knife to be tangent to the fixed knife, the height between the limiting board and the working table determines the width of the aluminum foil, thereby determining the thickness of the aluminum honeycomb core, and the sheared aluminum foil is pushed in the direction of the discharge passage by the moving knife, as the above actions are repeated, the number of aluminum foil layers is increasing, forming an aluminum honeycomb core. Through the above structure, the present application realizes the fully automatic production of the aluminum honeycomb core, improves the production efficiency of the honeycomb core, reduces the labor cost, improves the production efficiency of the aluminum honeycomb core, and also ensures the quality of the finished product of the aluminum honeycomb core.

### BRIEF DESCRIPTION OF THE DRAWINGS

The drawings are intended to provide a further understanding of the present application, and are intended to be a part of the present invention, and the illustrative embodiments of the present application and their description are used to explain the present application, and is not intended to limit the application. In the drawing:

FIG. 1 is a process flow chart of the aluminum honeycomb core production method of the embodiments;

FIG. 2 is a structure view of the aluminum honeycomb core production device of the embodiments;

FIG. 3 is an overall view of the aluminum honeycomb core production device of the embodiments;

FIG. 4 a structure view of the anti-tear board of the embodiments;

FIG. 5 a structure of the guiding mechanism of the embodiment;

FIG. 6 a structure view of the second gumming mechanism of the embodiments;

FIG. 7 a structure view of the first gumming mechanism of the embodiments;

FIG. 8 a structure view of the glue-scraping blade of the embodiments;

In the figure: 10, cutting mechanism; 20, driving mechanism; 11, working table; 12, limiting board; 13, moving knife; 14, fixed knife; 15, discharging passage; 131, pushing part; 1311, anti-tear board; 151, discharging outlet; 152, shearing part; 30, guiding mechanism; 31, guiding board; 32, guiding passage; 311, hollow structure; 321, feeding end; 322, discharging end; 40, first gumming mechanism; 50, second gumming mechanism; 60, guide roller; 70, pressure roller; 80, glue-storing cavity; 90, glue-scraping blade; 91, glue outlet.

### DESCRIPTION OF EMBODIMENTS

The present application will be further described in conjunction with the accompanying drawings and specific embodiments. It should be noted that, without conflict, the embodiments or technical characteristics described below may be arbitrarily combined to form a new embodiment.

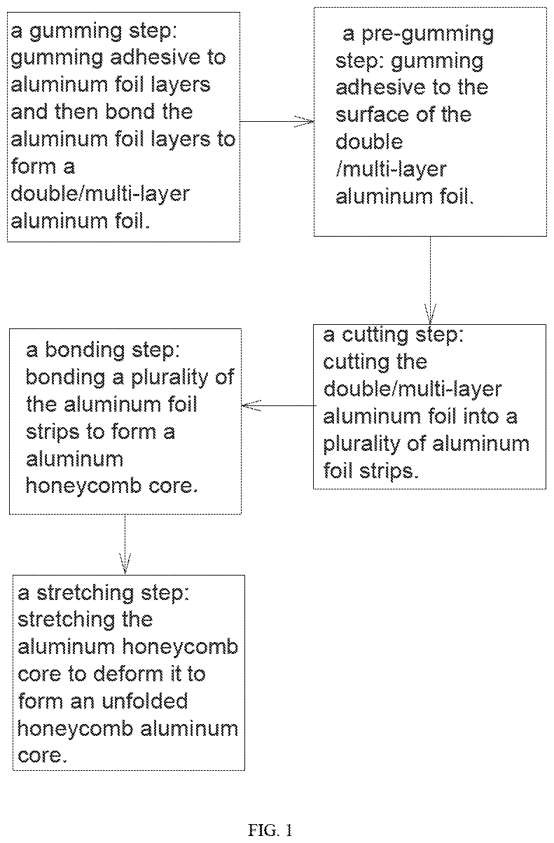

As shown in FIG. 1, in order to improve the strength and the flame retardancy performance of the honeycomb core, the present application applies aluminum foil to the honeycomb core structure, thereby providing an aluminum honeycomb core production method, comprising the following process steps:

a gumming step: gumming adhesive to aluminum foil layers and then bond the aluminum foil layers to form a double/multi-layer aluminum foil;

and gumming parallel glue lines on the surface of the aluminum foil layer at equal intervals along the length direction thereof, stacking the gummed aluminum foil layer with another aluminum foil layer, and then forming a double-layer aluminum foil by thermocompression bonding; and forming a first glue line layer between the two aluminum foil layers;

the double-layer aluminum foil can directly enter a subsequent pre-gumming step, or can further enter the subsequent pre-gumming, step after the plurality of the double-layer aluminum foils are stacked and bonded to form a multi-layer aluminum foil, and forming a second glue line layer between any two adjacent two-layer aluminum foils;

a pre-gumming step: gumming adhesive to the surface of the double/multi-layer aluminum foil;

and gumming parallel glue lines on the surface of the double/multi-layer aluminum foil at equal intervals along the length direction thereof, and forming the second glue line layer on the gummed side surface of the double/multi-layer aluminum foil; the glue line of the first glue line layer and the second glue line layer is parallel and staggered;

a cutting step: cutting the double/multi-layer aluminum foil;

according to the thickness requirement of the aluminum honeycomb core, cutting the double/multi-layer aluminum foil along the width direction of the double/multi-layer aluminum foil, and cutting the double/multi-layer aluminum foil into a plurality of aluminum foil strips of the same size;

a bonding step: bonding a plurality of the aluminum foil strips;

according to the area requirement of the aluminum honeycomb core, setting the orientations of the second glue line layer of the aluminum foil strips to a consistent orientation, and stacking and bonding a plurality of the aluminum foil strips in sequence, and the plurality of the aluminum fail strips are parallel; so that a plurality of the first glue line layers and a plurality of the second glue line layers are alternately bonded to form an aluminum honeycomb core.

The aluminum foil has higher mechanical strength than the liner paper used in the conventional paper honeycomb core, applying aluminum foil to the field of honeycomb cores that not only makes the honeycomb core has better performance in compression resistance and shock resistance, but also has non-flammable property to make that the aluminum honeycomb core board not ignite the inner honeycomb core layer during a fire, that is, it has better flame retardant performance, and also can solve the problem that the current paper honeycomb core shrinks in the honeycomb paper core board. However, due to the material properties of the aluminum foil, for example, in the producing method of the conventional honeycomb paper core, in the final cuffing step, the aluminum foils will be pressed against each other due to the properties of the metal, which makes the aluminum foil difficult to stretch and expand in the later steps, and the conventional paste is also difficult to ensure the reliability of the bonding between aluminum foils. Therefore, by the above methods, pre-cutting the aluminum foil layers before it being stacked and bonded, thereby avoiding the above situations and improving the production quality of the aluminum honeycomb core.

In order to ensure that the honeycomb cells in the aluminum honeycomb core have the same size, thereby ensuing the mechanical strength of the aluminum honeycomb core, the interval between any two adjacent glue lines of the first glue line layer is the same as the interval between any two adjacent glue lines of the second glue line layer.

Doing ultrasonic cleaning of the aluminum foil layer before the gumming step, so that the hot melt adhesive is not easily peeled off after being applied to the surface of the aluminum foil layer, thereby ensuring the bonding strength between the aluminum foil layers.

The aluminum honeycomb core production method the method further comprises a stretching step after the bonding step; after the glue line in the aluminum honeycomb core is air-dried and solidified, applying a relatively outward pulling force to both ends of the aluminum honeycomb core in a direction perpendicular to the aluminum foil layer, to cause tensile deformation of the aluminum honeycomb core to form a unfolded honeycomb core.

Preferably, in order to save the costs without affecting the mechanical strength of the aluminum honeycomb core, the thickness of the aluminum foil layer is 0.02 to 0.08 mm.

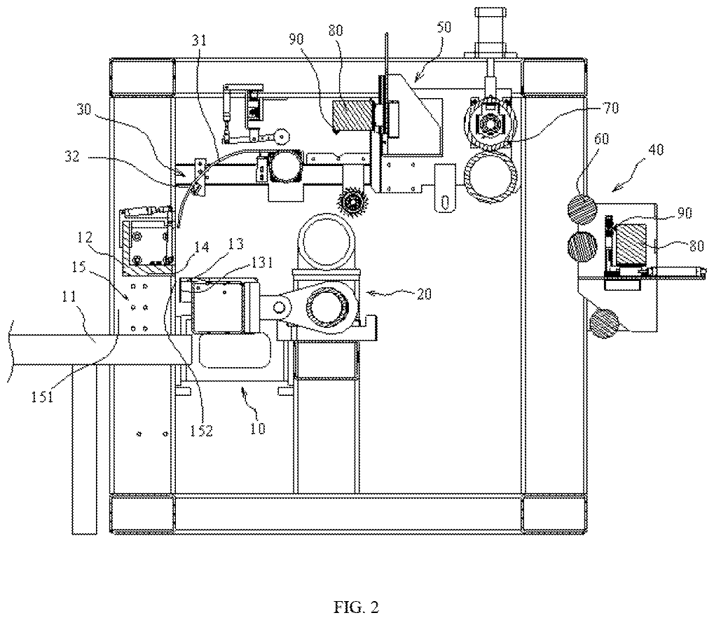

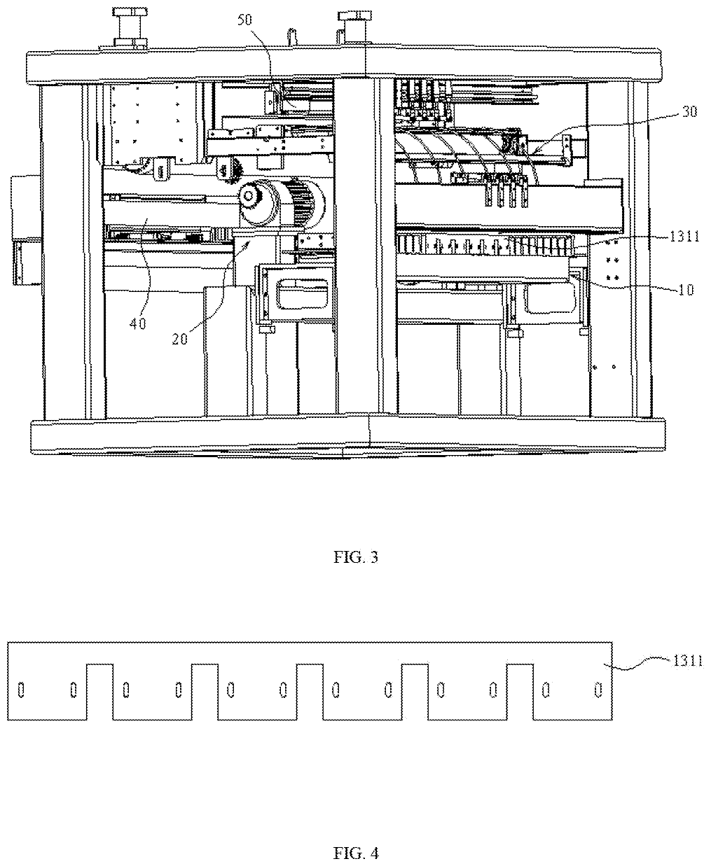

As shown in FIG. 2-4, according to the above method for manufacturing an aluminum honeycomb core, the present embodiment also provides an aluminum honeycomb core production device, comprising: a cutting mechanism 10 and a driving mechanism 20, and the driving mechanism 20 is used for driving the cutting mechanism 10 to shear the aluminum foil layer; the cutting mechanism 10 comprises a working table 11, a limiting board 12, a moving knife 13 and a fixed knife 14; the limiting board 12 is located above the working table 11 and forms a discharging passage 15 with the working table 11 the discharging passage 15 is for exporting the aluminum honeycomb core; the discharging passage 15 is horizontally disposed, one end forms a discharging outlet 151, the other end forms a shearing part 152; in this embodiment, the lower side of the working table 11 is provided with a lifting mechanism (not shown in the FIGs) for driving the working table 11 away from the limiting board 12 or close to the limiting board 12, the working table 11 is adjusted by the lifting mechanism to adjust the height of the discharging end 322 passage, when the aluminum foil layer is vertically import between the moving knife 13 and the fixed knife 14 from the upper of the cuffing mechanism 10, the end of the aluminum foil layer abuts against the working table 11 and is perpendicular to the working table 11, the moving knife 13 is drivingly connected to the driving mechanism 20 located at one side of the shearing part 152, the fixed knife 14 is fixed on the limiting board 12 and disposed opposite to the moving knife 13; the driving mechanism 20 is configured to drive the moving knife 13 to reciprocate along the direction of the discharging passage 15, to make moving knife 13 tangent to the fixed knife 14; the discharging passage 15 is parallel to the horizontal plane; the moving knife 13 and the fixed knife 14 are arranged up and down, the cutting edge of the fixed knife 14 is horizontally tangent to the cutting edge of the moving knife 13, by driving the moving knife 13 to be tangent to the fixed knife 14, the aluminum foil layer can be cut into aluminum foil strips that has the same height with the discharging outlet 151; before the aluminum foil layer enters the cutting mechanism 10, the surface of the aluminum foil layer need to be gummed glue lines at intervals, for a plurality of layers of aluminum foil strips to stack and bond; therefore, a plurality of notches (not shown in the FIGs) are provided on the moving knife 13 and there is spacing between adjacent slots, to prevent the aluminum foil layer being adhered to the fixed knife 14 by the glue line when the aluminum foil layer are sheared by the moving knife 13 and the fixed knife 14, so that to prevent the aluminum foil layer from cannot being continuously to conveyed forward; the lower portion of the moving knife 13 has a pushing part 131 for pushing the aluminum foil strip to move along the direction of the discharging passage 15 to discharging outlet 151 for a distance; and in order to prevent the aluminum foil strip from being torn or adhered to the moving knife 13 by shearing stress after shearing, the surface of the pushing part 131 is provided with an anti-tear board 1311; during the cutting process, the anti-tear board 1311 is supporting supported on the rear surface of the aluminum foil strip to prevent the aluminum foil from being deformed and torn, and then the moving knife 13 is moves away the discharging passage 15 to complete a cutting action, and the aluminum foil is being continuously conveyed between the fixed knife 14 and the moving knife 13, and the multi-layer aluminum foil strips are sequentially bonded to form into an aluminum honeycomb core by continuously completing the repeating the cutting action.

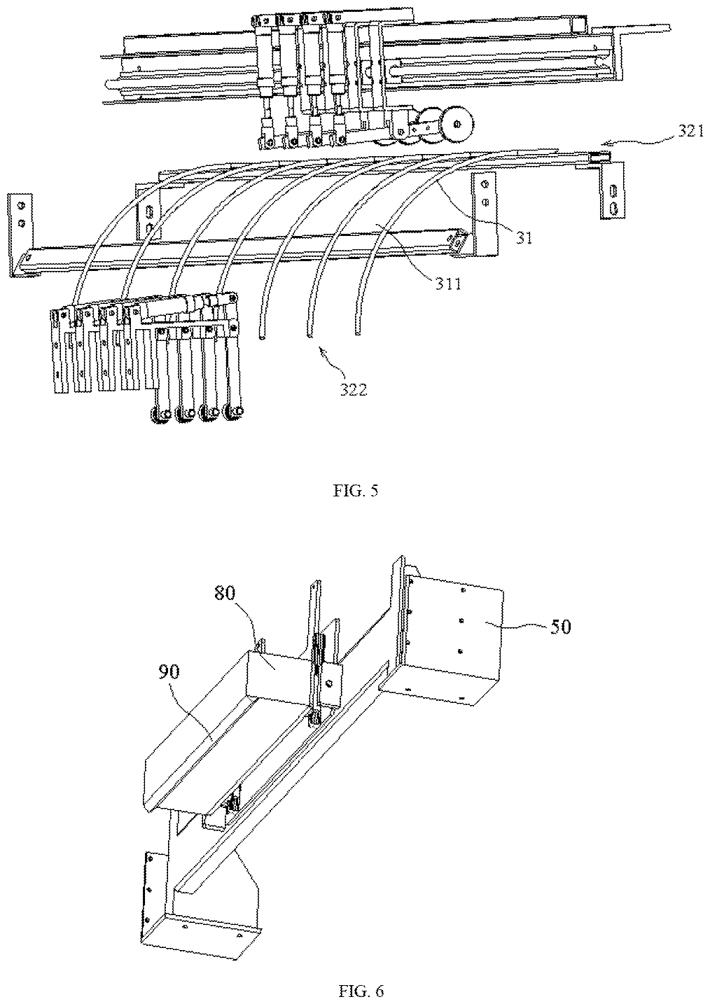

As shown in FIG. 5, in order to achieve the state in which the aluminum honeycomb core can be continuously produced, the aluminum honeycomb core production device further comprises a guiding mechanism 30; the guiding mechanism 30 is disposed above the cutting mechanism 10 for guiding the glued double/multi-layer aluminum foil to the cutting mechanism 10 for cutting the glued double/multi-layer aluminum foil by the cutting mechanism 10; the guiding mechanism 30 comprises a guiding board 31 and a stopping assembly; a guiding passage 32 for the double/multi-layer aluminum foil to pass through is formed between the guiding board 31 and the stopping assembly (not shown in the FIGs), the guiding passage 32 is in communication with the discharging passage 15 for the aluminum foil layer to pass through; in this embodiment, the surface of the guiding board 31 is provided a plurality of hollow structure 311s communicating two sides of the guiding board 31, so that the air would not be sealed between the guiding board 31 and the aluminum foil layer during conveying process of the aluminum foil, thereby preventing the aluminum foil from the influence of the air pressure so that the aluminum foil layer can be laid flat on the guiding board 31; of course, in the other embodiments, the guiding board 31 can also use a multi-bacillary structure that a plurality of rods with uniform arcs are arranged side by side to form a hollow structure 311 between the rod bodies.

The guiding passage 32 has is curved; one end of the guiding passage 32 forms a feeding end 321, and the other end of the guiding passage 32 forms a discharging end 322, the extension line of the feeding end 321 intersects with the extension line of the discharging end 322 at 90 degrees; the line formed between the discharging end 322 and the shearing part 152 is perpendicular to the discharging passage 15; after the aluminum foil layer enters the guiding passage 32 from the feeding end 321, it extends to the shearing part 152 formed between the working table 11 and limit plate along with its own weight and along the guide of the stopping assembly and the curved guiding passage 32; the discharging end 322 extends into the cutting mechanism 10 and is connects to the discharging passage 15, and it located between the moving knife 13 and the fixed knife 14, the fixed knife 14 and the moving knife 13 reciprocally cut the aluminum foil layer.

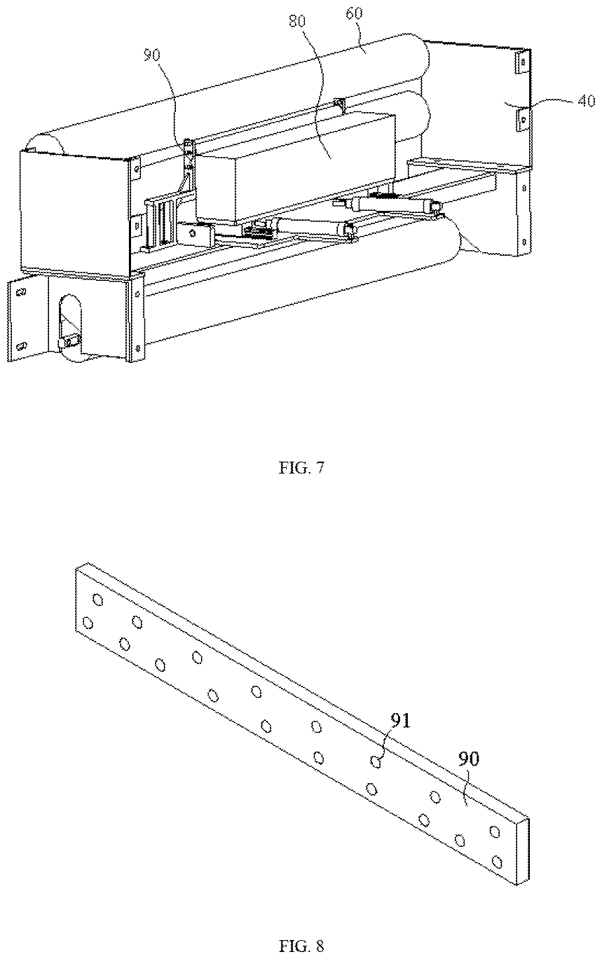

As shown in FIGS. 6 to 8, the aluminum honeycomb core production device further comprises a first gumming mechanism 40 and a second gumming mechanism 50; the first gumming mechanism 40 and the second gumming mechanism 50 are both connected to an external hot melt adhesive machine; the first gumming mechanism 40 and the second gumming mechanism 50 are disposed on the frame and are arranged stagger from each other, a plurality of guide roller 60s and a pressure roller 70 for bonding the aluminum foil layer are disposed between the first gumming mechanism 40 and the second gumming mechanism 50; the second gumming mechanism 50 is at the same level as and the feeding end 321; in the using process of the present embodiment, two rolls of aluminum foil unwinding roller are disposed on the outer side of the first gumming mechanism 40, and the two rolls of the aluminum foil unwinding roller are respectively unwound toward the first gumming mechanism 40 of the present embodiment, two layers of aluminum foil are simultaneously passed above and below the first gumming mechanism 40, and the surface of the aluminum foil located below the first gumming mechanism 40 is coated with evenly spaced glue lines, and then the two lavers of the aluminum foil are guided by the guide roller 60 and bonded, the bonded double/multi-layer aluminum foil is guided to the downside of the secondary gumming mechanism, and the secondary gumming mechanism coats adhesive to the surface of the bonded double/multi-layer aluminum foil, and then the aluminum foil layer being turned to enter the cutting mechanism 10 by the guiding mechanism 30 for cutting, thereby improving the producing efficiency of the aluminum honeycomb core, and also meeting the bonding requirement of the aluminum foil layer.

The first gumming mechanism 40 and the second gumming mechanism 50 each comprise glue-storing cavity 80 and a glue-scraping blade 90; the glue-storing cavity 80 is in communication with the external hot melt adhesive machine, the glue-storing cavity 80 is configured to storage the hot melt adhesive exported and supplied by the external hot melt adhesive machine and to pre-heat the hot melt adhesive; the glue-scraping blade 90 is installed below the glue-storing cavity 80, a plurality of glue outlet 91s are equidistantly disposed at the glue-scraping blade 90 along the length direction of the glue-storing cavity 80, and the glue outlet 91s are communicate with the interior of the glue-storing cavity 80; the orthographic projections of the glue outlet 91s of the first gumming mechanism 40 and the glue outlet 91s of the second gumming mechanism 50 in the direction of the first gumming mechanism 40 and the second gumming mechanism 50 are staggered.

1. An aluminum honeycomb core production method, comprising, the following steps:
a gumming step gumming adhesive to aluminum foil layers and, then bond the aluminum foil layers to form a double/multi-layer aluminum foil;
and gumming parallel glue lines on the surface of the aluminum foil layer at equal intervals along the length direction thereof stacking the gummed aluminum foil layer with another aluminum foil layer, and then forming a double-layer aluminum foil by thermocompression bonding and forming a first glue line layer between the two aluminum foil layers;
the double-layer aluminum foil can directly enter a subsequent pre-gumming step, or can further enter the subsequent pre-gumming step after the plurality of the double-layer aluminum foils are stacked and bonded to form a multi-layer aluminum foil, and forming a second glue line layer between any two adjacent two-layer aluminum foils;
a pre-gumming step: gumming adhesive to the surface of the double/multi-layer aluminum foil;
and gumming parallel glue lines on the surface of the double/multi-layer aluminum foil at equal intervals along the length direction thereof, and forming the second glue line layer on the gummed side surface of the double/multi-layer aluminum foil; the glue line of the first glue line layer and the second glue line layer is parallel and staggered;
a cutting step: cutting the double/multi-layer aluminum foil;
according to the thickness requirement of the aluminum honeycomb core, cutting the double/multi-layer aluminum foil along the width direction of the double/multi-layer aluminum foil, and cutting the double/multi-layer aluminum foil into a plurality of aluminum foil strips of the same size;
a bonding step: bonding a plurality of the aluminum foil strips;
according to the area requirement of the aluminum honeycomb core, setting the orientations of the second glue line layer of the aluminum foil strips to a consistent orientation, and stacking and bonding a plurality of the aluminum foil strips in sequence, and the plurality of the aluminum strips are parallel; so that a plurality of the first glue line layers and a plurality of the second glue line layers are alternately bonded to form an aluminum honeycomb core.

2. The aluminum honeycomb core production method according to claim 1, wherein the interval between any two adjacent glue lines of the first glue line layer is the same as the interval between any two adjacent glue lines of the second glue line layer.

3. The aluminum honeycomb core production method according to claim 1, wherein doing ultrasonic cleaning of the aluminum foil layer before the gumming step.

4. The aluminum honeycomb core production method according to claim 1, wherein the gumming step and the pre-gumming step both apply hot melt adhesive to gum the aluminum foil layer and the double/multi-layer aluminum foil.

5. The aluminum honeycomb core production method according to claim 1, wherein the method further comprises a stretching step after the bonding step; after the glue line in the aluminum honeycomb core is air-dried and solidified, applying a relatively outward pulling force to both ends of the aluminum honeycomb core in a direction perpendicular to the aluminum foil layer, to cause tensile deformation of the aluminum honeycomb core to form a unfolded honeycomb core.

6. The aluminum honeycomb core production method according to claim 1, wherein the thickness of the aluminum foil layer is 0.02 to 0.08 mm.

7. An aluminum honeycomb core production device, comprising:
a cutting mechanism and a driving mechanism, and the driving mechanism is used for driving the cutting mechanism to shear the aluminum foil layer; the cutting mechanism comprises a working table, a limiting board, a moving knife and a fixed knife; the limiting board is located above the working table and forms a discharging passage with the working table, the discharging passage is for exporting the aluminum honeycomb core; the discharging passage is horizontally disposed, one end forms a discharging outlet, the other end forms a shearing part; the moving knife is drivingly connected to the driving mechanism located at one side of the shearing part, the fixed knife is fixed on the limiting board and disposed opposite to the moving knife; the driving mechanism is configured to drive the moving knife to reciprocate along, the direction of the discharging passage, to make moving knife tangent to the fixed knife; the discharging passage is parallel to the horizontal plane; the moving knife and the fixed knife are arranged up and down, the cutting edge of the fixed knife is horizontally tangent to the cutting edge of the moving knife.

8. The aluminum honeycomb core product on device according to claim 7, wherein the aluminum honeycomb core production device further comprises a guiding mechanism; the guiding mechanism is disposed above the cutting mechanism for guiding the glued double/multi-layer aluminum foil to the cutting mechanism for cutting the glued double/multi-layer aluminum foil by the cutting mechanism; the guiding mechanism comprises a guiding board and a stopping assembly; a guiding passage for the double/multi-layer aluminum foil to pass through is formed between the guiding board and the stopping assembly, the guiding passage is in communication with the discharging passage;
the guiding passage has is curved; one end of the guiding passage forms a feeding end, and the other end of the guiding passage forms a discharging end, the extension line of the feeding end intersects with the extension line of the discharging end at 90 degrees; the line formed between the discharging end and the shearing part is perpendicular to the discharging passage.

9. The aluminum honeycomb core production device according to claim 8, wherein the aluminum honeycomb core production device further comprises a first gumming mechanism and a second gumming mechanism; the first gumming mechanism and the second gumming mechanism are both connected to an external hot melt adhesive machine; the first gumming mechanism and the second gumming mechanism are disposed on the frame and are arranged stagger from each other, a plurality of guide rollers and a pressure roller for bonding the aluminum foil layer are disposed between the first gumming mechanism and the second gumming mechanism; the second gumming mechanism at the same level as and the feeding end.

10. The aluminum honeycomb core production device according to claim 9, wherein the first gumming mechanism and the second gumming mechanism each comprise a glue-storing cavity and a glue-scraping blade; the glue-storing cavity is in communication with the external hot melt adhesive machine, the glue-storing cavity is configured to storage the hot melt adhesive exported and supplied by the external hot melt adhesive machine and to pre-heat the hot melt adhesive; the glue-scraping blade is installed below the glue-storing cavity, a plurality of glue outlets are equidistantly disposed at the glue-scraping blade along the length direction of the glue-storing cavity, and the glue outlets are communicate with the interior of the glue-storing cavity; the orthographic projections of the glue outlets of the first gumming mechanism and the glue outlets of the second gumming mechanism in the direction of the first gumming mechanism and the second gumming mechanism are staggered.
